(19) United States
(12) Patent Application Publication
(10) Pub. No.: US 2025/0371724 A1
(43) Pub. Date: Dec. 4, 2025

(54) IMAGE PROCESSING APPARATUS, IMAGE PROCESSING METHOD, AND MEDIUM

(71) Applicant: CANON KABUSHIKI KAISHA, Tokyo (JP)

(72) Inventor: Waki MIDORIKAWA, Kanagawa (JP)

(21) Appl. No.: 19/221,658

(22) Filed: May 29, 2025

(30) Foreign Application Priority Data
May 30, 2024 (JP) 2024-088274

(51) Int. Cl. G06T 7/33; G06T 7/73

(52) U.S. Cl. CPC G06T 7/33; G06T 7/73

(57) ABSTRACT

An image processing apparatus is provided. The apparatus searches for a feature point which is included in a second image obtained by the image capturing apparatus and which corresponds to the feature point included in a first image from a search range set in the second image. The apparatus determines a positional shift between the feature point included in the first image and the feature point which is included in the second image. The apparatus determines a new search range to be set in the second image on a basis of information indicating a history of positional shifts that have been determined respectively for a plurality of second images obtained in sequence.

### BACKGROUND

### Field of the Disclosure

The present disclosure relates to an image processing apparatus, an image processing method, and a non-transitory computer-readable medium, and especially to a technique for aligning images.

### Description of the Related Art

An orientation of an image capturing apparatus may change under the influence of vibration and the like while the image capturing apparatus is performing shooting of the same object multiple times. In this case, images of the object in the discrete captured images do not necessarily match one another. In view of this, a technique is known that aligns images obtained by performing image capture in different time periods. Such a technique can be used as preprocessing for processing that is executed under the premise that images of the same object match among images. For example, in processing for extracting a foreground with use of a background subtraction method, the foreground can be extracted with high accuracy by using a plurality of images in which the positions of the same object have been aligned so that they match one another. As another example, a video can be generated by compositing together captured images of a plurality of cameras. In this case, orientations of the respective cameras can be calculated through calibration. Then, correction processing for alignment is executed with respect to videos obtained by the respective cameras on the basis of the orientations of the respective cameras, and then the videos can be composited together.

Such alignment can be performed by searching for a feature which corresponds to a feature included in one image and which is included in another image. Such association can be established based on similarity between images in the vicinity of the features or feature amounts thereof. U.S. Pat. No. 10,121,262 discloses a technique to align a first image obtained through image capture during calibration (hereinafter referred to as a reference image) and a plurality of second images used in video generation (hereinafter referred to as correction target images). According to U.S. Pat. No. 10,121,262, shifts between the reference image and the correction target images are detected using patch data extracted from the reference image.

### SUMMARY

According to an embodiment, an image processing apparatus comprises one or more memories storing instructions and one or more processors that execute the instructions to: obtain information of a feature point included in a first image obtained by an image capturing apparatus; search for a feature point which is included in a second image obtained by the image capturing apparatus and which corresponds to the feature point included in the first image from a search range set in the second image; determine a positional shift between the feature point included in the first image and the feature point which is included in the second image and which corresponds to the feature point included in the first image; determine a new search range to be set in the second image on a basis of information indicating a history of positional shifts that have been determined respectively for a plurality of second images obtained in sequence; and update the search range on a basis of the determined new search range.

According to another embodiment, an image processing apparatus comprises one or more memories storing instructions and one or more processors that execute the instructions to: obtain information of a feature point included in a first image obtained by an image capturing apparatus; search for a feature point which is included in a second image obtained by the image capturing apparatus and which corresponds to the feature point included in the first image from a search range set in the second image, and determine a positional shift between the feature point included in the first image and the feature point included in the second image; determine whether an orientation change of the image capturing apparatus when capturing the second image is equal to or smaller than a predetermined reference, and when the orientation change has been determined to be equal to or smaller than the predetermined reference, determine a new search range to be set in the second image on a basis of information indicating the positional shift evaluated for the second image; and update the search range on a basis of the determined new search range.

According to still another embodiment, an image processing method comprises: obtaining information of a feature point included in a first image obtained by an image capturing apparatus; searching for a feature point which is included in a second image obtained by the image capturing apparatus and which corresponds to the feature point included in the first image from a search range set in the second image; determining a positional shift between the feature point included in the first image and the feature point which is included in the second image and which corresponds to the feature point included in the first image; determining a new search range to be set in the second image on a basis of information indicating a history of positional shifts that have been determined respectively for a plurality of second images obtained in sequence; and updating the search range on a basis of the determined new search range.

According to yet another embodiment, a non-transitory computer-readable medium stores a program executable by a computer to perform a method comprising: obtaining information of a feature point included in a first image obtained by an image capturing apparatus; searching for a feature point which is included in a second image obtained by the image capturing apparatus and which corresponds to the feature point included in the first image from a search range set in the second image; determining a positional shift between the feature point included in the first image and the feature point which is included in the second image and which corresponds to the feature point included in the first image; determining a new search range to be set in the second image on a basis of information indicating a history of positional shifts that have been determined respectively for a plurality of second images obtained in sequence; and updating the search range on a basis of the determined new search range.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram showing an exemplary configuration of an image processing system according to an embodiment.

FIG. 2 is a diagram showing an exemplary format of data of a feature point.

FIG. 3 is a diagram showing an exemplary hardware configuration of an image processing apparatus.

FIG. 4A to FIG. 4D are diagrams showing examples of a search range for feature points.

FIG. 5 is a flowchart showing an example of a method of calculating a feature point correction amount.

FIG. 6 is a flowchart showing an example of processing in an image processing method according to an embodiment.

FIG. 7 is a flowchart of an example of processing for determining whether to apply a feature point correction amount.

FIG. 8 is a flowchart of an example of processing for applying a feature point correction amount.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

An orientation of an image capturing apparatus may change due to not only vibration, but also a temperature change related to sunshine and the like, or a passage of time. An orientation change caused by vibration generally occurs on a short-term basis. On the other hand, there is a possibility that an orientation change caused by a temperature change or a passage of time occurs on a long-term basis. Also, the influence of the long-term orientation change has a possibility of increasing a positional shift between images in a reference image and a correction target image. In this case, there is an increased possibility that a feature inside the correction target image corresponding to a feature inside the reference image cannot be discovered. If a search range for features inside the correction target image is increased to address the foregoing issue, a processing time period is extended. Furthermore, there is a possibility that the accuracy of alignment decreases as a result of performing matching between erroneous correspondence points.

An embodiment according to the present disclosure can improve the accuracy of alignment between images shot by an image capturing apparatus in a case where a stable orientation change occurs in the image capturing apparatus.

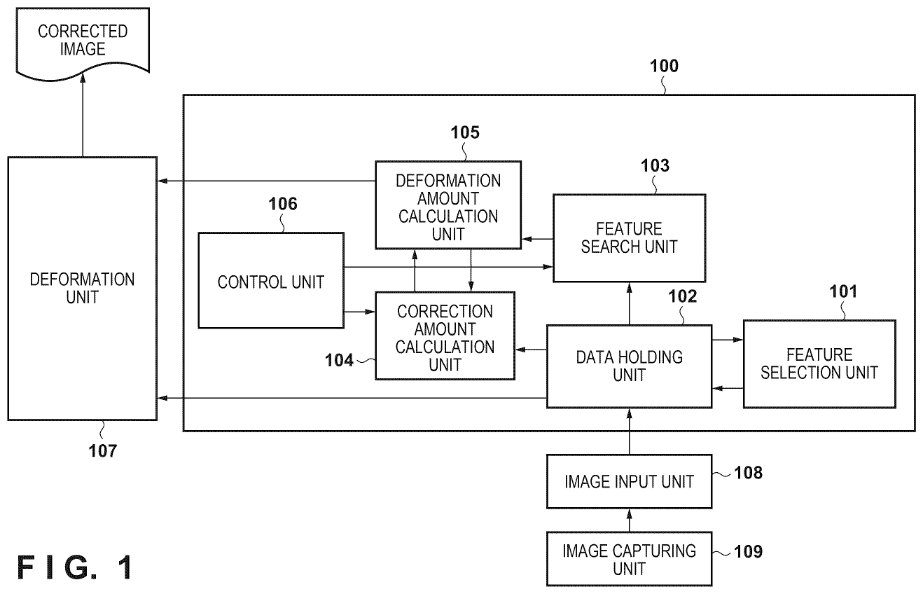

FIG. 1 shows an exemplary configuration of an image processing apparatus according to an embodiment. An image processing apparatus 100 includes a feature selection unit 101, a data holding unit 102, a feature search unit 103, a correction amount calculation unit 104, a deformation amount calculation unit 105, and a control unit 106. Also, the image processing apparatus 100 is connected to a deformation unit 107, an image input unit 108, and an image capturing unit 109. An image processing system according to an embodiment includes the image processing apparatus 100, the deformation unit 107, the image input unit 108, and the image capturing unit 109.

The image capturing unit 109 generates a reference image (a first image) and a correction target image (a second image) by capturing an object. Also, the image capturing unit 109 can generate a plurality of correction target images in sequence by capturing the object repeatedly. The reference image and the correction target images show the same object. Note that the reference image and the correction target images may include an object that changes, in addition to an object that does not change. For example, the image capturing unit 109 may generate the reference image and the correction target images by capturing a field at different times. Here, on the field, which is an object, a further object like a player may be in motion. In this case, too, the reference image and the correction target images can be aligned based on feature points corresponding to an object that does not change, such as the field. Note that feature points will be described later.

The image input unit 108 saves the reference image and the correction target images generated by the image capturing unit 109 in the data holding unit 102.

The deformation unit 107 executes correction processing on the reference image and/or the correction target images to align the reference image and the correction target images. This correction processing can be executed based on positional shifts between feature points included in the reference image and feature points included in the correction target images, which have been determined by the deformation amount calculation unit 105. In the present embodiment, the deformation unit 107 executes the correction processing on the correction target images on the basis of deformation amounts calculated by the deformation amount calculation unit 105. The deformation unit 107 can generate corrected images by applying the deformation amounts calculated by the deformation amount calculation unit 105 to the correction target images.

A method of the correction processing is not limited in particular. As will be described later, the deformation amounts calculated by the deformation amount calculation unit 105 indicate positional shifts between feature points included in the reference image and corresponding feature points included in the correction target images. In other words, these deformation amounts indicate association between feature points included in the reference image and feature points included in the correction target images. Based on such association related to each of the plurality of feature points, the deformation amount calculation unit 105 can calculate a correction parameter between the reference image and the correction target images. For example, this correction parameter can be represented as an affine transformation or a homography transformation. Then, the deformation unit 107 can generate corrected images by applying the correction processing that uses such a correction parameter to the correction target images. Note that when calculating the correction parameter, the deformation unit 107 may use later-described deformation amounts in the direction θ (i.e., rotation amounts). Meanwhile, the deformation unit 107 may execute the correction processing on the reference image for the purpose of alignment.

Images after the correction processing can be used for a variety of purposes. For example, an image processing unit (not shown) included in the image processing apparatus 100 can execute processing for separating a foreground from a background inside a corrected image with use of the reference image and the corrected image. In this way, a foreground region can be extracted from the corrected image. Furthermore, the image processing unit (not shown) included in the image processing apparatus 100 can generate a three-dimensional model of an object with use of the reference image and the corrected image in accordance with, for example, a volume intersection method.

The image capturing unit 109 can be realized by an image capturing apparatus, such as a camera. At least one of the deformation unit 107 and the image input unit 108 can be realized by an information processing apparatus, such as a server and a computer. Meanwhile, the image processing apparatus 100 may include at least one of the deformation unit 107 and the image input unit 108. Also, the image capturing unit 109 may include the image input unit 108.

The feature selection unit 101 obtains information of feature points included in the reference image. For example, the feature selection unit 101 can save data of a first feature point group, which includes a plurality of feature points selected from the reference image, in the data holding unit 102. In the present specification, each feature point included in the first feature point group may be referred to as a first feature point. Data of a feature point can include, for example, the coordinates of the feature point and a feature amount of the feature point.

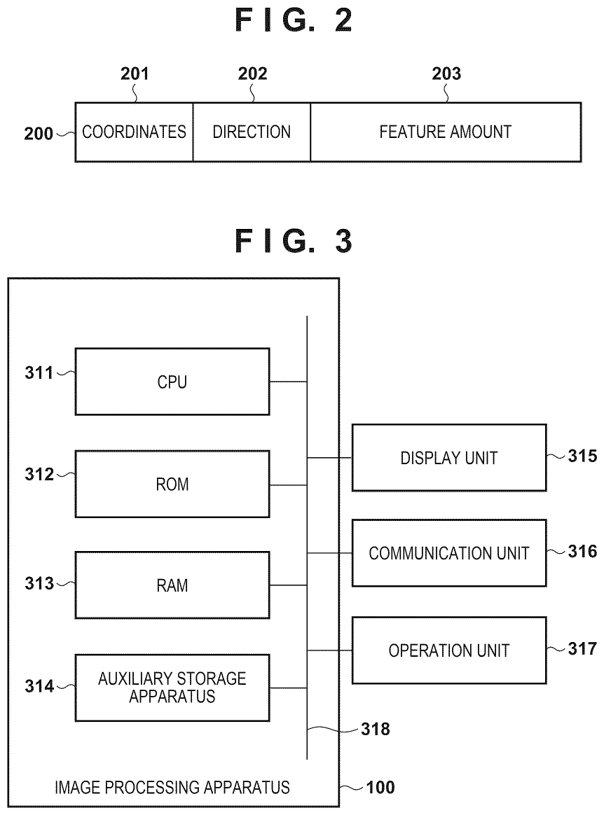

A method of deciding on feature points is not limited in particular. For example, the feature points may be grid points in the reference image, or may be points selected from among the grid points in the reference image. Also, the feature points may be points indicating edges inside the reference image. In the following description, the feature selection unit 101 extracts the first feature point group with use of the method described in U.S. Pat. No. 10,121,262. Furthermore, a method of calculating a feature amount is not limited in particular, either. For example, a feature amount can be calculated based on pixel values in a region around a feature point. As a specific example, a feature amount may be calculated by inputting a partial image around a feature point to a neural network. Furthermore, a partial image in a periphery region of a feature point, per se, may be used as a feature amount. In the following description, a feature amount is a set of values calculated in accordance with an algorithm described in U.S. Pat. No. 10,121,262. FIG. 2 shows an exemplary format of data 200 of a feature point used in the following description. Data 200 of a feature point includes coordinates 201, a direction 202, and a feature amount 203. The direction 202 is calculated in accordance with the algorithm described in U.S. Pat. No. 10,121,262.

Note that the feature selection unit 101 need not extract feature points. For example, feature points inside the reference image and feature amounts thereof may be decided in advance. In this case, the feature selection unit 101 can obtain information of the feature points that has been stored in advance in a memory, such as an auxiliary storage apparatus 314.

The feature search unit 103 searches for feature points which are included in a correction target image and which correspond to feature points included in the reference image. In the present embodiment, the feature search unit 103 searches for feature points from a search range set in the correction target image. Here, as will be described later, a search range for coordinates of feature points included in the reference image has been set in advance. The feature search unit 103 can search for a corresponding feature point included in the correction target image with respect to each feature point in the first feature point group. For example, the feature search unit 103 can evaluate each of the differences between the feature amount of a feature point included in the reference image and the feature amounts of respective points inside the search range for the correction target image. Then, based on the result of evaluation of the differences, feature points which are included in the correction target image and which correspond to feature points included in the reference image can be determined. In this example, the difference between the feature amount of a feature point included in the reference image and the feature amount of a corresponding feature point is equal to or smaller than a threshold. Furthermore, the difference between the feature amount of a feature point included in the reference image and the feature amount of a corresponding feature point is smaller than the differences between the feature amount of the feature point included in the reference image and the feature amounts of other points inside the search range.

In the present specification, a feature point which is included in the correction target image and which corresponds to a first feature point included in the reference image may be referred to as a second feature point. In the following description, the feature search unit 103 searches for the coordinates and the directions inside the correction target image with which the feature amounts closest to the respective feature points in the first feature points are obtained. Upon finishing the search for corresponding feature points with respect to all first feature points included in the first feature point group, the feature search unit 103 notifies the deformation amount calculation unit 105 of the search result.

As described above, in the present embodiment, the feature search unit 103 searches the search range set in the correction target image for a feature point which is included in the correction target image and which corresponds to a feature point included in the reference image. On the other hand, the feature search unit 103 may search the search range set in the reference image for a feature point which is included in the reference image and which corresponds to a feature point included in the correction target image.

The deformation amount calculation unit 105 determines a positional shift between a feature point included in the reference image and a feature point which is included in the correction target image and which corresponds to the feature point included in the reference image. This positional shift can be indicated by, for example, the amounts of movement in the X direction and the Y direction. In the present specification, information indicating this positional shift may be referred to as a deformation amount. Furthermore, the feature search unit 103 can determine the positional shift in the above-described manner with respect to each feature point in the first feature point group. In the following description, the feature search unit 103 calculates the amounts of changes in coordinates and directions between a first feature point inside the reference image and a second feature point that has been searched for inside the correction target image as a deformation amount corresponding to the first feature point.

Based on information indicating a history of positional shifts that have been determined respectively for a plurality of correction target images obtained in sequence, the correction amount calculation unit 104 decides on a new search range for the correction target images. In the present embodiment, the correction amount calculation unit 104 calculates a feature point correction amount that is used in deciding on the search range for the correction target images as will be described later. Furthermore, the correction amount calculation unit 104 can request the control unit 106 to update a setting of the feature point correction amount.

Based on the new search range decided by the correction amount calculation unit 104, the control unit 106 updates a setting of the search range for the correction target images that is used by the feature search unit 103 to search for feature points. Through later-described processing, the control unit 106 can update the setting of the feature point correction amount in a case where the shifts between the reference image and the correction target images stably exceed a predetermined value. Furthermore, the control unit 106 can control each unit of the image processing apparatus 100.

The image processing apparatus according to the present embodiment can be realized by a computer that includes a processor and a memory. FIG. 3 is a block diagram showing an exemplary hardware configuration of the image processing apparatus 100. As shown in FIG. 3, the image processing apparatus 100 includes a CPU 311, a ROM 312, a RAM 313, an auxiliary storage apparatus 314, and a bus 318. Furthermore, the image processing apparatus 100 is connected to a display unit 315, a communication unit 316, and an operation unit 317.

The CPU 311 controls the entirety of the image processing apparatus 100 with use of a computer program or data stored in the ROM 312 or the RAM 313. The ROM 312 stores a program or data that need not be changed. The RAM 313 temporarily stores a program or data supplied from the auxiliary storage apparatus 314, or such data as image data supplied from the outside via the communication unit 316. The auxiliary storage apparatus 314 is, for example, a hard disk or a solid-state drive. Images input from the communication unit 316 can be accumulated in the auxiliary storage apparatus 314. In this way, the functions of each unit shown in FIG. 1 can be realized by a processor like the CPU 311 executing a program stored in a memory like the ROM 312, the RAM 313, or the auxiliary storage apparatus 314.

The display unit 315 is, for example, a display apparatus like a liquid crystal display. The display unit 315 can display a graphical user interface (GUI) that is used by a user to use the image processing apparatus 100, or a corrected image. The operation unit 317 is, for example, an apparatus that accepts a user input, such as a keyboard and a mouse. The operation unit 317 can input various types of instructions to the CPU 311 in accordance with a user operation. The communication unit 316 is a communication apparatus for communicating with an external apparatus. For example, in a case where the image processing apparatus 100 is connected by wire to an external apparatus, a communication path, such as a LAN cable, is connected to the communication unit 316. Furthermore, in a case where the image processing apparatus 100 has a function of performing wireless communication with an external apparatus, the communication unit 316 includes an antenna. The bus 318 connects among each unit of the image processing apparatus 100, the display unit 315, the communication unit 316, and the operation unit 317. The bus 318 conveys information among these units.

Next, a description is given of an example of a search range in which the feature search unit 103 searches for a feature point. The following describes a case where the feature search unit 103 searches a correction target image for a feature point corresponding to a feature point A included in a first feature point group extracted from a reference image. The feature search unit 103 calculates feature amounts related to points which are in the vicinity of the coordinates of the feature point A and which are inside the search range inside the correction target image. The feature amount related to a point can be calculated based on pixel values in a partial region centered at the point. Then, the feature search unit 103 determines that a point with a feature amount closest to the feature amount of the feature point A is a feature point corresponding to the feature point A. Hereinafter, the feature point which has been detected from the correction target image and which corresponds to the feature point A may be referred to as a feature point B.

In the present embodiment, the feature search unit 103 searches for the coordinates and the directions with which a feature amount closest to the feature amount of the feature point A is obtained. The following describes a case where the two-dimensional coordinates of the feature point A are (x′, y′). Also, in this example, the search range is M×N pixels. Furthermore, in the following description, coordinates represent a grid point between pixels. Note that coordinates may represent the central coordinates of a pixel.

The feature search unit 103 scans points in the search range that are respectively represented by coordinates (x′−M/2, y′−N/2) to (x′+M/2, y′+N/2) inside the correction target image, and calculates feature amounts of the respective directions with respect to each point. Also, in this example, a feature amount related to each point is calculated based on pixel values inside a partial region of M×N pixels. In a case where the direction of the feature point A is 0°, the feature search unit 103 can scan each point inside the coordinates (x′−M/2, y′−N/2) to (x′+M/2, y′+N/2) in the correction target image rotated by −0°, and calculate feature amounts from the M×N partial region in each direction with respect to each point. Note that the size of the search range need not match the size of the partial region that is referred to in calculating feature amounts.

The above has described an example in which the coordinates of a feature point in a reference image are the same as the coordinates of a feature point in a correction target image. On the other hand, correction can be made even in a case where later-described stable shifts have occurred between the coordinates of a feature point in a reference image and the coordinates of feature points in correction target images. In the present embodiment, the search range for the correction target images corresponding to the coordinates of a feature point (a feature point A) included in the reference image can be corrected. This corrected search range is set using a feature point correction amount. The feature point correction amount has values in the X direction and the Y direction. Also, the feature point correction amount indicates a relative position of the coordinates of a reference point in the search range in relation to the coordinates of the feature point A. Again, the search range is a region of a predetermined size centered at the reference point (e.g., a region of M×N pixels). For example, when the feature point correction amount=(0, 0), that is to say, when stable shifts do not exist between the coordinates of a feature point in a reference image and the coordinates of feature points in correction target images, the search range is a region of M×N pixels centered at the coordinates (x′, y′). On the other hand, for example, when the feature point correction amount=(−3, −4), that is to say, when stable shifts exist between the coordinates of a feature point in a reference image and the coordinates of feature points in correction target images, the search range is a region of M×N pixels centered at the coordinates (x′−3, y′−4). In this example, the size of the search range is constant (e.g., M×N pixels) before and after the correction, that is to say, the search range is shifted in accordance with the feature point correction amount.

Here, the deformation amount calculation unit 105 may determine a positional shift of the feature point B relative to the reference point. In the present specification, information indicating a positional shift of the feature point B relative to the reference point is referred to as a displacement amount. In this case, the deformation amount calculation unit 105 can calculate a positional shift, that is to say, a deformation amount of the feature point B relative to the feature point A on the basis of the displacement amount and the feature point correction amount. Specifically, the deformation amount calculation unit 105 can calculate the deformation amount by adding the feature point correction amount to the coordinate values indicated by the displacement amount.

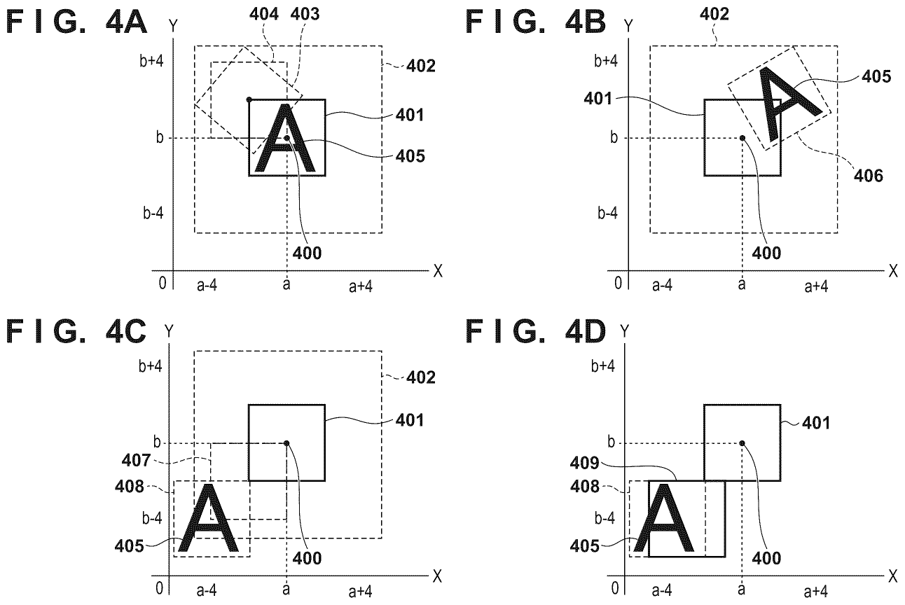

Processing executed by the feature search unit 103 will be further described with reference to FIGS. 4A to 4D. In this example, a reference image and a correction target image are obtained by capturing an object 405 that does not change. Also, in this example, the feature search unit 103 calculates feature amounts in relation to a partial region of 4×4 pixels (M=4 and N=4) centered at a feature point.

FIG. 4A shows an example of a case where a camera is in the same orientation when shooting the reference image and the correction target image. Note that in FIGS. 4A to 4C, the feature point correction amount is (0, 0). In a case where the coordinates of a feature point A (a feature point 400) are (a, b), the feature search unit 103 searches for a feature point at which a feature amount corresponding to the feature point A is obtained while scanning each point inside the coordinates (a−2, b−2) to (a+2, b+2) represented by a search range 401 inside the correction target image.

A region 402 of the correction target image is a region inside the correction target image that is referred to when searching for the feature point corresponding to the feature point A. A region 403 and a region 404 represent regions that are respectively referred to in calculating the feature amounts corresponding to the directions 0° and 45° at the coordinates (a−2, b+2) inside the region 402. In a case where the camera is in the same orientation when shooting the reference image and the correction target image, the feature amount calculated from the region of the direction 0° centered at the coordinates (a, b) inside the correction target image (which matches the search range 401 in FIG. 4A) is the closest to the feature amount of the feature point A. In this case, the coordinates and the directions related to the feature point A are the same as the coordinates and the directions related to a corresponding feature point B inside the correction target image. Therefore, the displacement amount of the detected feature point (X, Y, θ)=(0, 0, 0). Furthermore, in this example, as the feature point correction amount=(0, 0), the deformation amount between the feature point A and the feature point B (X, Y, θ)=(0, 0, 0).

FIG. 4B shows an example of a case where, due to an orientation change of the camera, the feature point A (feature point 400) that was at the coordinates (a, b) in the reference image has moved to the coordinates (a+2, b+2) in the correction target image, and furthermore, an image around the feature point has rotated by −30°. In this example, a feature amount calculated from a region 406, which is obtained by rotating a region of 4×4 pixels centered at the coordinates (a+2, b+2) inside the correction target image by −30°, is the closest to the feature amount of the feature point A. In this case, the displacement amount of the detected feature point (X, Y, θ)=(2, 2, −30°). Furthermore, as the feature point correction amount=(0, 0), the deformation amount between the feature point A and the feature point B (X, Y, θ)=(2, 2, −30°).

FIG. 4C shows a case where, due to an orientation change of the camera, the feature point A (feature point 400) that was at the coordinates (a, b) in the reference image has moved to the coordinates (a−4, b−4) in the correction target image. In this example, a region 408 corresponding to the coordinates (a−6, b−6) to (a−2, b−2) in the correction target image is a region corresponding to the feature point A. However, as the search range of the feature search unit 103 extends to the coordinates (a−2, b−2), a region that is referred ends at a region 407 (in the case of the direction 0°). In this example, as an object shown in the region 407 and an object shown in the region 408 are different, a feature amount that corresponds to (e.g., that is the same as) the feature amount of the feature point A is not obtained from the correction target image.

In this case, the feature search unit 103 judges that a feature point corresponding to the feature point A does not exist inside the correction target image. Also, a deformation amount related to the feature point A is not calculated. In other words, the feature point A is not used for alignment. Note that the feature search unit 103 can notify the deformation amount calculation unit 105 of an error in a case where a corresponding feature point has not been discovered with respect to every feature point included in the first feature point group. The feature search unit 103 may notify the deformation amount calculation unit 105 of an error in a case where the number of first feature points for which corresponding feature points have been discovered is equal to or smaller than a threshold. In this case, processing related to the correction target image that is currently processed is ended, and correction processing is not executed in relation to this correction target image.

On the other hand, in the present embodiment, the search range is corrected based on the feature point correction amount. FIG. 4D shows a case where the camera has undergone an orientation change similar to that of FIG. 4C. In this example, (X, Y)=(−3, −4) is set as the feature point correction amount. In this case, the feature search unit 103 searches a search range indicated by a region 409, that is to say, a range of the coordinates (a−2−3, b−2−4) to (a+2−3, b+2−4). Through this processing, the feature search unit 103 can detect a region 408 in which a feature amount corresponding to the feature point A (feature point 400) is obtained. In this case, the displacement amount of the detected feature point B (X, Y, θ)=(−2, −2, 0°). Furthermore, as the feature point correction amount=(−3, −4), the deformation amount between the feature point A and the feature point B (X, Y, θ)=(−5, −6, 0°).

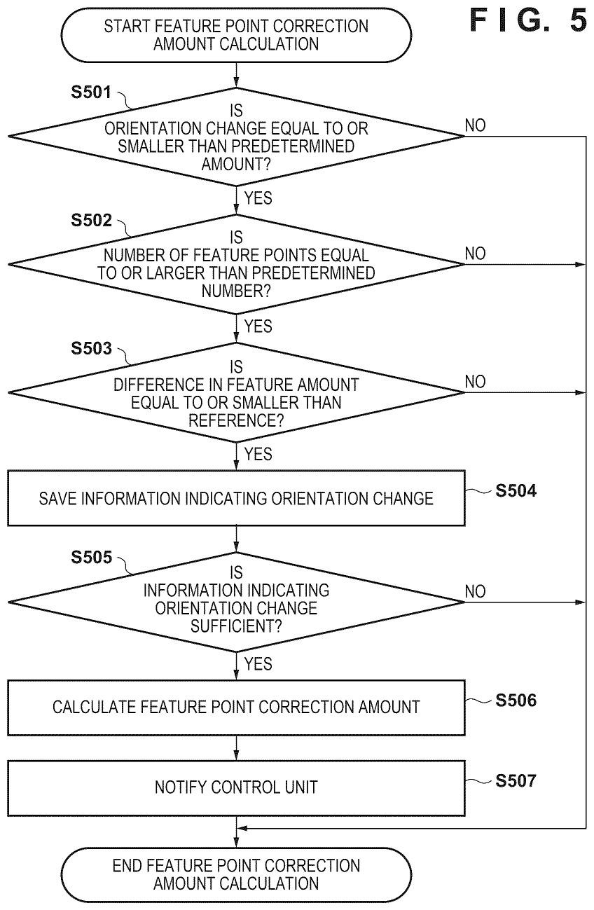

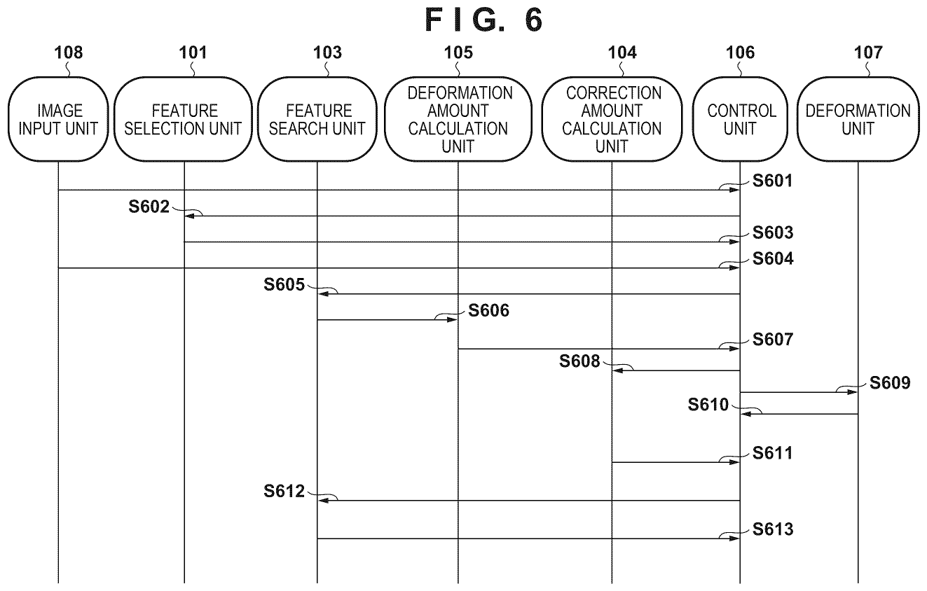

FIG. 5 is a flowchart of processing in which the correction amount calculation unit 104 calculates a feature point correction amount and updates a correction value used by the image processing apparatus 100. As will be described later with reference to FIG. 6, the control unit 106 performs control so that the correction amount calculation unit 104 executes processing with respect to each frame (step S608). That is to say, processing of the correction amount calculation unit 104 is executed with respect to each of a plurality of correction target images. Note that the deformation amount calculation unit 105 has calculated deformation amounts before the start of processing shown in FIG. 5 (step S606).

In the present embodiment, the correction amount calculation unit 104 calculates a feature point correction amount on the basis of a history of deformation amounts that have been evaluated for each of the plurality of correction target images. As will be described later, this feature point correction amount is used to update a search range for feature points. By thus using a history of information indicating orientation changes, the correction amount calculation unit 104 can calculate the feature point correction amount that is based on stable orientation changes of the camera.

In an embodiment described below, the correction amount calculation unit 104 decides on a new search range on the basis of deformation amounts that have been evaluated with respect to each of one or more second images selected in accordance with a predetermined condition from among deformation amounts that have been evaluated with respect to each of the plurality of correction target images. That is to say, the correction amount calculation unit 104 can calculate the feature point correction amount on the basis of deformation amounts that have been selected in accordance with the predetermined condition. Meanwhile, the correction amount calculation unit 104 can exclude unselected deformation amounts from the bases for calculation of the feature point correction amount (e.g., deformation amounts saved in the data holding unit 102). For example, in a case where it is estimated that deformation amounts are under the influence of a temporary orientation change of the camera caused by vibration and the like, the correction amount calculation unit 104 can exclude such deformation amounts. With this configuration, the correction amount calculation unit 104 can calculate the feature point correction amount while suppressing the influence of a temporary orientation change of the camera.

In steps S501 to S503, the correction amount calculation unit 104 determines whether to use deformation amounts in order to calculate the feature point correction amount on the basis of an index that has been set in advance. In an embodiment, the predetermined condition includes a condition related to an orientation change of the camera when capturing a correction target image. For example, in step S501, a degree of an orientation change of the camera between frames is used as the index. Specifically, the correction amount calculation unit 104 determines whether an orientation change of the camera when capturing a correction target image is equal to or smaller than a predetermined reference. Then, based on the result of this determination, it can be determined that the correction target is to be selected. In a case where an orientation change of the camera between frames is large, it is estimated that the calculated deformation amounts are under the influence of a temporary orientation change of the camera. In this case, the deformation amounts are not used to calculate the feature point correction amount.

The correction amount calculation unit 104 may determine a degree of an orientation change of the camera on the basis of information indicating an orientation of the camera when capturing a correction target image. For example, the correction amount calculation unit 104 can determine an orientation change of the camera when capturing a correction target image of a current frame on the basis of an orientation of the camera when capturing the correction target image of the current frame and an orientation of the camera when capturing a correction target image of a previous frame. The correction target image of the current frame is a correction target image captured at a first time. Also, the correction target image of the previous frame is a correction target image captured at a second time that precedes the first time. Information indicating an orientation of the camera can be indicated by components in the x direction, y direction, and z direction (e.g., the pan direction, tilt direction, and roll direction). Such an orientation of the camera when capturing a correction target image can be determined on the basis of deformation amounts. For example, a relative orientation change of the camera between the time when a reference image was captured and the time when a correction target image was captured can be determined based on association between feature points included in the reference image and feature points included in the correction target image. As stated earlier, such association can be indicated by deformation amounts calculated by the deformation amount calculation unit 105. Then, the correction amount calculation unit 104 may compare the aforementioned relative orientation change of the camera between the previous frame and the current frame.

In this case, the correction amount calculation unit 104 compares an orientation (x, y, z) of the camera when capturing the correction target image of the current frame with an orientation (x, y, z) of the camera when capturing the correction target image of the previous frame. Then, the correction amount calculation unit 104 determines that an orientation change of the camera is small in a case where each of the differences in the x, y, and z directions is equal to or smaller than a predetermined value. In this case, processing proceeds to step S502. Otherwise, processing of FIG. 5 is ended.

On the other hand, the correction amount calculation unit 104 may determine a degree of an orientation change of the camera on the basis of correction parameters calculated by the deformation unit 107. For example, the correction amount calculation unit 104 may compare correction parameters calculated by the deformation unit 107 between the previous frame and the current frame.

Furthermore, a degree of an orientation change of the camera may be evaluated from the differences between deformation amounts in the previous frame and the current frame. Specifically, the correction amount calculation unit 104 compares deformation amounts (X, Y, θ) determined in the previous frame with deformation amounts (X, Y, θ) determined in the current frame. In the present embodiment, deformation amounts are calculated with respect to feature points included in the first feature point group, respectively. The correction amount calculation unit 104 may calculate a statistical value (e.g., an average value) of each component of deformation amounts related to the respective feature points with respect to each of the previous frame and the current frame. Then, the correction amount calculation unit 104 can determine that an orientation change of the camera is small in a case where each of the differences between statistical values of components in the X, Y, and θ directions is equal to or smaller than a predetermined value. Note that the correction amount calculation unit 104 may compare only X components and Y components of the determined deformation amounts between the previous frame and the current frame.

In this way, a degree of an orientation change of the camera may be evaluated based on a result of estimation of an orientation of the camera, or may be evaluated based on another information (e.g., deformation amounts or correction parameters) influenced by an orientation of the camera. Furthermore, in an embodiment, a degree of a positional change of the camera between frames is used as the index. That is to say, a degree of change in the position and/or orientation of the camera between frames can be used as the index.

In step S502, whether an object that acts as a feature has changed, whether there is a blockage caused by an obstacle, a result of association between feature points, or the number of associated feature points is used as the index. In a case where feature points selected from a background are sometimes blocked by a foreground, the number of feature points may decrease in some frames. Also, in a case where a shape of an object used as a feature point changes due to a climate condition or a passage of time, a difference may arise between feature amounts in the reference image and the correction target image. In these cases, there is a possibility that the accuracy of determination of deformation amounts decreases. For example, in a case where the number of associated feature points, that is to say, the number of feature points in the correction target image that have been detected as being in correspondence with feature points in the reference image, is small, there is a possibility that there is a large error in deformation amounts calculated based on the association.

In an embodiment, the predetermined condition includes a condition related to the number of feature points which have been searched for from the correction target image and which correspond to feature points included in the reference image. In this case, the correction amount calculation unit 104 determines whether the number of second feature points which have been searched for from the correction target image and which respectively correspond to feature points in the first feature point group is equal to or larger than a threshold. Then, the correction amount calculation unit 104 can select the correction target image on the basis of the result of this determination. That is to say, the correction amount calculation unit 104 can determine that deformation amounts are to be used to calculate the feature point correction amount in a case where it has been determined that the number of associated feature points is equal to or larger than a predetermined number. In this case, processing proceeds to step S503. Otherwise, processing of FIG. 5 is ended. With this configuration, it is expected that deformation amounts with a small error are used to calculate the feature point correction amount. Note that a specific index is not limited in particular. For example, it is permissible to use the number of feature points for which deformation amounts that are outliers have been obtained when the feature search unit 103 has associated feature points with each other. Specifically, processing may proceed to step S503 in a case where the percentage of feature points for which deformation amounts that are outliers have been obtained to the total number of feature points for which effective deformation amounts have been obtained is equal to or smaller than a predetermined value.

In step S503, the difference between the reference image and the correction target image is used as the index. In an embodiment, the predetermined condition includes a condition related to the difference between the correction target image and the reference image. For example, the correction amount calculation unit 104 can determine whether the difference between information (e.g., feature amounts) of first feature points included in the reference image and information (e.g., feature amounts) of second feature points that have been searched for from the correction target image is equal to or smaller than a predetermined reference. Then, the correction amount calculation unit 104 can select the correction target image on the basis of the result of the determination. For example, in a case where the correction amount calculation unit 104 has determined that the difference between the feature amounts is equal to or smaller than the predetermined reference, processing proceeds to step S504. Otherwise, processing of FIG. 5 is ended.

In a case where such a difference between the feature amounts is large, there is a possibility that the accuracy of association is low, and thus an error in deformation amounts is large. In view of this, when comparing feature amounts in the reference image with feature amounts in the correction target image, the feature search unit 103 can calculate the difference between a feature amount related to a first feature point and a feature amount related to a second feature point with respect to each feature point in the first feature point group. Then, the feature search unit 103 can save the differences between feature amounts that have been calculated for the respective first feature points. At this time, the correction amount calculation unit 104 can use a sum total of the values of the differences between feature amounts as the above-described difference between feature amounts. That is to say, the correction amount calculation unit 104 can determine whether a sum total of the differences that have been calculated with respect to the feature points included in the first feature point group is equal to or smaller than a predetermined threshold, and select a second image when the sum total of the differences has been determined to be equal to or smaller than the predetermined threshold.

As another example, the result of comparison between the reference image and a corrected image can be used as an index. That is to say, in a case the correction amount calculation unit 104 has determined that the difference between the reference image and the corrected image is equal to or smaller than a predetermined reference, processing proceeds to step S504. Otherwise, processing of FIG. 5 is ended. With this configuration, the feature point correction amount can be calculated based on frames with a small difference, that is to say, deformation amounts with high reliability. As a specific example, the correction amount calculation unit 104 can compare pieces of peripheral pixel information related to one or more corresponding feature points between the corrected image and the reference image. Then, the correction amount calculation unit 104 can use similarity degrees of such pieces of peripheral pixel information as information indicating the difference between the reference image and the corrected image. The similarity degrees can be calculated through, for example, calculation of normalized cross-correlation related to predetermined regions around the coordinates of feature points.

Thus far, various indices that can be used to determine whether to use deformation amounts to calculate the feature point correction amount have been described as steps S501 to S503. Note that it is not necessary to use all of the above-described indices, and the use of three types of indices is not indispensable, either. For example, only one of steps S502 and S503 may be executed. Also, the order of steps S501 to S503 is not limited. Furthermore, instead of steps S501 to S503, the correction amount calculation unit 104 can use one or more of the above-described indices to determine that deformation amounts are to be used to calculate the feature point correction amount. In this case, processing proceeds to step S504. On the other hand, in a case where the correction amount calculation unit 104 has determined that a condition for ending processing, which has been set in advance, is satisfied in accordance with the above-described indices, processing of FIG. 5 is ended.

In another embodiment, the correction amount calculation unit 104 skips processing for determining whether to use deformation amounts to calculate the feature point correction amount on the basis of an index that has been set in advance. In this case, too, the correction amount calculation unit 104 can calculate the feature point correction amount on the basis of a history of deformation amounts related to a plurality of past frames in later-described processing. Therefore, the feature point correction amount that reflects stable orientation changes of the camera can be calculated while suppressing the influence of a temporary orientation change of the camera.

In step S504, the correction amount calculation unit 104 saves the deformation amounts that have been determined with respect to the frame that is currently processed in the data holding unit 102.

In step S505, the correction amount calculation unit 104 determined whether there is a history of deformation amounts that are sufficient for calculation of the feature point correction amount. In the present embodiment, a history of deformation amounts related to past frames is used for calculation of the feature point correction amount. In view of this, the correction amount calculation unit 104 can determine whether deformation amounts that have been determined with respect to a predetermined number of frames have been saved in the data holding unit 102. In a case where there are sufficient deformation amounts, processing proceeds to step S506. Otherwise, processing of FIG. 5 is ended.

In step S506, the correction amount calculation unit 104 calculates the feature point correction amount. The correction amount calculation unit 104 calculates the feature point correction amount on the basis of information of the deformation amounts saved in the data holding unit 102, that is to say, information indicating a history of positional shifts between the first feature points and the second feature points that have been determined with respect to the plurality of correction target images obtained in sequence. As described above, information of the deformation amounts related to the correction target images that have been selected in accordance with the predetermined condition in steps S501 to S503 is stored in the data holding unit 102.

In the present embodiment, the feature point correction amount is denoted by (X, Y). The correction amount calculation unit 104 can decide on a new search range on the basis of a statistical value of deformation amounts that have been evaluated for each of the selected correction target images. For example, the correction amount calculation unit 104 can calculate the feature point correction amount for the X direction and the Y direction on the basis of deformation amounts in the X direction and the Y direction related to the plurality of frames. For example, the correction amount calculation unit 104 can use a statistical value, such as an average value and a median value, of the deformation amounts that have been determined in the past as the feature point correction amount.

In the present embodiment, deformation amounts are calculated with respect to feature points included in the first feature point group, respectively. The correction amount calculation unit 104 can calculate the feature point correction amount on the basis of the deformation amounts that are related to the frames and the respective feature points. For example, for each feature point, the correction amount calculation unit 104 can calculate a statistical value (e.g., an average value) of the deformation amounts in the X direction and the Y direction related to the plurality of frames. Furthermore, the correction amount calculation unit 104 can calculate a statistical value (e.g., an average value) of statistical values of the deformation amounts in the X direction and the Y direction that have been calculated for the respective feature points as the feature point correction amount (X, Y). The feature point correction amount calculated in this way can be commonly used to set a search range with respect to all feature points included in the first feature point group.

On the other hand, the feature point correction amount may be calculated independently with respect to each of the feature points included in the first feature point group. In this case, a statistical value (e.g., an average value) of the deformation amounts in the X direction and the Y direction that has been calculated for each feature point in relation to the plurality of frames can be used as the feature point correction amount of each feature point. That is to say, with respect to each first feature point, a search range that conforms to the corresponding feature point correction amount can be set. Then, with respect to each feature point in the first feature point group, the feature search unit 103 can search for a second feature point from inside the corresponding search range.

Note that the correction amount calculation unit 104 can calculate the feature point correction amount on the basis of the deformation amounts related to a predetermined number of frames. This predetermined number is not limited in particular. For example, in a case where stable deviations of the orientation of the camera are small, or in a case where data of sufficient deformation amounts that can be used for calculation of the feature point correction amount can be attained in a short time period because the level of vibration is low, the correction amount calculation unit 104 can use an average of the deformation amounts as the feature point correction amount. On the other hand, in a case where the orientation of the camera does not easily stabilize because the level of vibration is high, the correction amount calculation unit 104 may use a median value or an average value of the most recent deformation amounts, or the deformation amounts related to the latest several frames, as the feature point correction amount. Also, in a case where deformation amounts have a tendency to change in a specific direction, the correction amount calculation unit 104 can use a median value or an average value of the most recent deformation amounts, or the deformation amounts related to the latest several frames, as the feature point correction amount so as to reduce the influence of this tendency.

Furthermore, a method of calculating the feature point correction amount is not limited to the above-described methods. For example, the correction amount calculation unit 104 may calculate the feature point correction amount in accordance with a correction parameter that has been calculated by the deformation unit 107 with respect to each frame. Such a correction parameter is calculated based on deformation amounts. Therefore, the correction parameter indicates a positional shift between a first feature point and a second feature point. Therefore, this method, too, makes it possible to calculate the feature point correction amount on the basis of information indicating a history of deformation amounts, or on the basis of information indicating a history of positional shifts between a first feature point and a second feature point.

In step S507, the correction amount calculation unit 104 notifies the control unit 106 of completion of calculation of the feature point correction amount so as to reflect the feature point correction amount calculated in step S506 in the search range for feature points.

Next, an image processing method executed by the image processing apparatus 100 will be described with reference to FIG. 6. This method includes processing for applying a change in the search range for feature points on the basis of the feature point correction amount.

In step S601, the image input unit 108 saves a reference image in the data holding unit 102. The image input unit 108 notifies the control unit 106 of completion of inputting of the reference image.

In step S602, the control unit 106 instructs the feature selection unit 101 to extract feature points from the reference image. In this example, the control unit 106 extracts a first feature point group from the reference image.

In step S603, the feature selection unit 101 notifies the control unit 106 of completion of extraction of the first feature point group from the reference image.

In subsequent processing, the image input unit 108 inputs correction target images that respectively correspond to a plurality of frames to the image processing apparatus 100. The correction target images are saved in the data holding unit 102. The control unit 106 performs control to generate corrected images through processing executed for each correction target image.

In step S604, the image input unit 108 notifies the control unit 106 of completion of inputting of a correction target image. This notification may be made on a frame-by-frame basis. Also, this notification may be made in units of multiple frames (e.g., per video sequence). Processing of steps S605 to S610 is executed with respect to each of the input correction target images of the respective frames.

In step S605, the control unit 106 instructs the feature search unit 103 to search for feature points which are included in the correction target image and which correspond to feature points extracted from the reference image as stated earlier. In this example, the feature search unit 103 searches the correction target image for feature points that respectively correspond to feature points in the first feature point group.

Upon completion of the search with respect to every feature point in the first feature point group, the feature search unit 103 outputs the search result to the deformation amount calculation unit 105 in step S606. Also, the feature search unit 103 instructs the deformation amount calculation unit 105 to calculate deformation amounts. Then, the deformation amount calculation unit 105 can calculate deformation amounts related to the respective feature points as stated earlier. Note that as stated earlier, the correction amount calculation unit 104 may use feature amounts (e.g., the differences between feature amounts) as the above-described index. In this case, the deformation amount calculation unit 105 can save the feature amounts related to corresponding feature points included in the correction target image, which have been calculated at the time of search for feature points, in the data holding unit 102. Upon completion of calculation of the deformation amounts, the deformation amount calculation unit 105 notifies the control unit 106 of completion of processing in step S607.

In step S608, the control unit 106 instructs the correction amount calculation unit 104 to calculate the feature point correction amount. Then, the correction amount calculation unit 104 calculates the feature point correction amount with use of the method shown in FIG. 5.

In step S609, the control unit 106 instructs the deformation unit 107 to execute correction processing on the correction target image. The deformation unit 107 outputs a corrected image by executing the correction processing on the correction target image obtained from the data holding unit 102 with use of the method that has already been described.

Upon completion of the correction processing, the deformation unit 107 notifies the control unit 106 of completion of the processing in step S610. The image processing apparatus 100 repeats the foregoing processing with respect to each correction target image, thereby generating corrected images corresponding to the respective correction target images. Note that as stated earlier, the correction amount calculation unit 104 may use the result of comparison between a corrected image and the reference image as the above-described index. In this case, in order to make the determination of step S502, the control unit 106 may notify the correction amount calculation unit 104 of completion of generation of the corrected image after processing of step S610 has been completed.

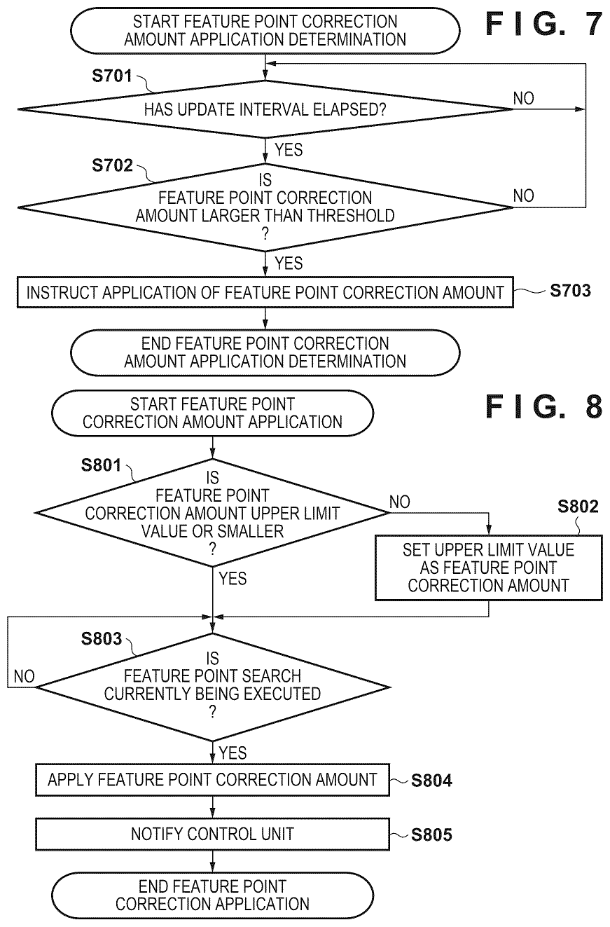

Upon completion of processing for calculating the feature point correction amount, the correction amount calculation unit 104 notifies the control unit 106 of completion of processing in step S611. In step S612, processing for applying the feature point correction amount to the feature search unit 103, which will be described later with reference to FIG. 7 and FIG. 8, is executed. Upon completion of this processing, the feature search unit 103 notifies the control unit 106 of completion of processing in step S613.

Thereafter, when a correction target image corresponding to a new frame has been input, processing from step S604 is repeated. At this time, the feature search unit 103 sets a search range for feature points in accordance with the feature point correction amount applied in step S612. Therefore, feature points can be searched for with higher accuracy in consideration of stable deviations of the orientation of the camera and positional shifts between feature points.

The following describes processing executed in step S612, which is for applying the feature point correction amount calculated by the correction amount calculation unit 104 in step S608 to the feature search unit 103.

In the present embodiment, in a case where stable deviations of the orientation of the camera have occurred, the control unit 106 issues an instruction for applying the feature point correction amount to the feature search unit 103. Specifically, the control unit 106 can determine whether to update a setting of a search range on the basis of the difference between a search range that acts as a reference and a new search range decided by the correction amount calculation unit 104. That is to say, the control unit 106 can determine whether to apply the feature point correction amount on the basis of the difference between a feature point correction amount that acts as a reference and a feature point correction amount calculated by the correction amount calculation unit 104. This feature point correction amount that acts as the reference may be an initial value, for example, (0, 0). In this case, the control unit 106 can determine that the feature point correction amount is to be applied when the feature point correction amount calculated by the correction amount calculation unit 104 is larger than a threshold that has been set in advance. The threshold is not limited in particular. For example, a threshold for the feature point correction amount in each of the X and Y directions may be half of the search range used by the feature search unit 103 in each of the X direction and the Y direction. In this case, the control unit 106 can determine that the feature point correction amount is to be applied when the feature point correction amount in the X direction or the Y direction exceeds the corresponding threshold. A deviation in the orientation of the camera includes a deviation caused by vibration in addition to a stable deviation. Therefore, the difference between the search range and displacement amounts of feature points that can arise due to vibration of the camera can be used as the threshold. This configuration makes it easy to discover corresponding feature points even in a case where vibration has been applied in addition to stable deviations of the orientation.

Furthermore, the feature point correction amount that acts as the reference may be the feature point correction amount that is currently set. That is to say, in a case where a feature point correction amount has already been applied, the control unit 106 can determine that a new feature point correction amount is to be applied when the difference between the feature point correction amount calculated by the correction amount calculation unit 104 and the feature point correction amount that is currently applied is larger than a threshold that has been set in advance.

Furthermore, it is not necessary to update the feature point correction amount on a frame-by-frame basis. For example, the correction amount calculation unit 104 may issue an instruction for applying the feature point correction amount to the feature search unit 103 when a predetermined time period (an update interval) has elapsed since the last update of the feature point correction amount. In this case, a time period that is sufficiently shorter than a time period in which stable orientation changes of the camera occur can be set as the update interval.

FIG. 7 is a flowchart showing an example of processing that is executed by the control unit 106 to determine whether to apply a feature point correction amount. In step S701, the control unit 106 waits for an elapse of a time period that has been set as an update interval since the last application of the feature point correction amount. In a case where the control unit 106 has determined that the update interval has elapsed, processing proceeds to step S702.

In step S702, the control unit 106 determines whether the feature point correction amount calculated by the correction amount calculation unit 104 is larger than the aforementioned threshold. In a case where the control unit 106 has determined that the feature point correction amount is larger than the threshold, processing proceeds to step S703. Otherwise, processing returns to step S701.

In step S703, the control unit 106 instructs the feature search unit 103 to execute processing for applying the feature point correction amount. FIG. 8 is a flowchart showing an example of processing for applying the feature point correction amount, which is executed by the feature search unit 103.

In step S801, the feature search unit 103 determines whether the feature point correction amount calculated by the correction amount calculation unit 104 is a correction value that can be set in the feature search unit 103. For example, the feature search unit 103 can determine whether the feature point correction amount is equal to or smaller than a predetermined upper limit value. As stated earlier, the feature point correction amount applied by the feature search unit 103 indicates values that are to be added to the X- and Y-coordinate values of a first feature point, respectively, to calculate a reference point for setting a search range for feature points in a correction target image. Also, in a case where a non-zero value is applied as the feature point correction amount, the feature search unit 103 adds the values of the X direction and the Y direction indicated by the feature point correction amount respectively to the calculated displacement amounts of a feature point in the X direction and the Y direction, thereby calculating a deformation amount with respect to the feature point.

In a case where the feature search unit 103 has determined that the feature point correction amount is equal to or smaller than the upper limit value, processing proceeds to step S803. Otherwise, processing proceeds to step S802. In step S802, the feature search unit 103 sets the upper limit value of applicable feature point correction amounts as a feature point correction amount. Thereafter, processing proceeds to step S803. Note that processing of steps S801 and S802 can be executed independently with respect to each of the X direction and Y direction.

In step S803, in a case where feature point search processing is currently being executed, the feature search unit 103 waits for the feature point search processing to end. In the present embodiment, processing for applying the feature point correction amount may be executed in parallel with the feature point search processing. Therefore, the feature search unit 103 can wait for the timing of completion of the feature search processing related to one frame. In this case, the feature search unit 103 can apply the feature point correction amount after the correction amount calculation unit 104 has calculated the feature point correction amount in step S608 on the basis of the feature point search processing in step S605. In this way, a feature point correction value is updated in step S804 at the timing of completion of the feature search processing related to one frame.

In step S804, the feature search unit 103 updates the feature point correction amount used in the search for a feature point, thereby applying the feature point correction amount. In this way, both of the correction values added to the reference point of the search range and the correction values added at the time of calculation of deformation amounts are switched to post-update values at the same timing. In step 805, the control unit 106 is notified of completion of the update of the feature point correction amount.

With this configuration, the correction amount calculation unit 104 can calculate a feature point correction amount indicating stable positional shifts between a reference image and a correction target image. Then, based on the feature point correction amount, the control unit 106 can set a search range for feature points that is used by the feature search unit 103 so that the search range includes a region that has a high possibility of including corresponding feature points. Note that processing of the present embodiment is equivalent to a search for corresponding feature points after executing correction processing (e.g., a translational movement) that conforms to the feature point correction amount with respect to one of the reference image and the correction target image. This is comparable to a search for corresponding feature points after removing stable positional shift components from the correction target image. In this case, deformation amounts of feature points before the removal of stable positional shift components can be calculated based on the displacement amounts calculated with respect to feature points that have been searched for, and on the feature point correction amount. Such equivalent configurations are substantially the same as the above-described embodiment, and are included in the above-described embodiment.

In step S501, the correction amount calculation unit 104 determines whether to use deformation amounts to calculate the feature point correction amount on the basis of a degree of an orientation change of the camera. At this time, the correction amount calculation unit 104 evaluates a degree of an orientation change of the camera from the differences between deformation amounts in a previous frame and a current frame. However, a method of determining an orientation change of the camera is not limited to this method. For example, the correction amount calculation unit 104 can determine an orientation change of the camera when capturing a correction target image on the basis of an output from a sensor included in the camera.

For example, the camera may include a gyro sensor. The gyro sensor can measure an orientation change (an angular velocity) of the camera. Such a sensor can output information indicating an orientation or an orientation change of the camera on a frame-by-frame basis. In this case, a reference image and a correction target image generated by the image capturing unit 109 can include information indicating an orientation of the camera, or information indicating an orientation change of the camera (e.g., a speed of an orientation change in each direction), in addition to pixel information. The information indicating an orientation or an orientation change of the camera can be indicated by components in the x direction, y direction, and z direction (e.g., the pan direction, tilt direction, and roll direction). In this case, the image input unit 108 can associate correction target images with pieces of information indicating orientations or orientation changes with use of information that identifies image frames, such as time codes. The image input unit 108 can save these pieces of information in the data holding unit 102.

In a case where pieces of information indicating orientations or orientation changes of the camera are usable in this way, the control unit 106 instructs the correction amount calculation unit 104 to use these pieces of information in step S608. The correction amount calculation unit 104 obtains, from the data holding unit 102, pieces of information indicating orientations or orientation changes of the camera related to frames corresponding to the correction target images that have been used by the deformation amount calculation unit 105 to calculate deformation amounts. Then, the correction amount calculation unit 104 can determine a degree of an orientation change of the camera on the basis of these pieces of information.

As a specific example, the correction amount calculation unit 104 may determine a degree of an orientation change of the camera on the basis of information indicating an orientation change of the camera related to a current frame. Also, a degree of an orientation change of the camera may be determined by comparing information indicating an orientation of the camera related to a current frame with information indicating an orientation of the camera related to a previous frame. For example, with respect to each of the x, y, and z directions, the correction amount calculation unit 104 can calculate the amount of change in a value indicating an orientation of the camera between a previous frame and a current frame. Then, it can be determined that an orientation change of the camera has occurred in a case where the amount of change related to one of the x, y, and z directions has exceeded a threshold. In this case, processing of FIG. 5 is ended. Otherwise, processing proceeds to step S502. This threshold can be set so that the camera can be deemed stationary in a case where the difference is equal to or smaller than the threshold.

In this way, based on a history of pieces of information indicating orientations or orientation changes of the camera, the correction amount calculation unit 104 can determine whether an orientation change of the camera has occurred. The correction amount calculation unit 104 may detect a time period in which an orientation of the camera does not change throughout continuous frames, and calculate the feature point correction amount with use of deformation amounts calculated by the deformation amount calculation unit 105 with respect to frames in which an orientation of the camera does not change.

In another embodiment, the deformation amount calculation unit 105 can determine whether an orientation change of the camera when capturing a correction target image is equal to or smaller than a predetermined reference. This determination can be made similarly to step S501. Then, when it has been determined that the orientation change is equal to or smaller than the predetermined reference, the deformation amount calculation unit 105 can decide on a new search range on the basis of information (e.g., deformation amounts) indicating a positional shift that has been evaluated with respect to the correction target image. With this configuration, the feature point correction amount can be calculated based on deformation amounts that have been less influenced by a temporary orientation change of the camera caused by vibration and the like. Therefore, the correction amount calculation unit 104 can calculate the feature point correction amount that is based on stable orientation changes of the camera. In such an embodiment, it is not indispensable to correct the feature point correction amount on the basis of information indicating a history of deformation amounts.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-088274, filed May 30, 2024, which is hereby incorporated by reference herein in its entirety.

What is claimed is:

1. An image processing apparatus comprising one or more memories storing instructions and one or more processors that execute the instructions to:
obtain information of a feature point included in a first image obtained by an image capturing apparatus;
search for a feature point which is included in a second image obtained by the image capturing apparatus and which corresponds to the feature point included in the first image from a search range set in the second image;
determine a positional shift between the feature point included in the first image and the feature point which is included in the second image and which corresponds to the feature point included in the first image;
determine a new search range to be set in the second image on a basis of information indicating a history of positional shifts that have been determined respectively for a plurality of second images obtained in sequence; and
update the search range on a basis of the determined new search range.

2. The image processing apparatus according to claim 1, wherein the one or more processors execute the instructions to determine the new search range on a basis of information indicating the positional shifts that have been evaluated respectively for one or more second images, wherein the information is selected, in accordance with a predetermined condition, from pieces of information indicating the positional shifts that have been evaluated respectively for the plurality of second images.

3. The image processing apparatus according to claim 2, wherein
the predetermined condition includes a condition related to an orientation change of the image capturing apparatus when capturing the second image.

4. The image processing apparatus according to claim 2, wherein the one or more processors execute the instructions to determine whether an orientation change of the image capturing apparatus when capturing the second image is equal to or smaller than a predetermined reference, and determine that the second image is to be selected on a basis of a result of the determination.

5. The image processing apparatus according to claim 3, wherein the one or more processors execute the instructions to determine an orientation change of the image capturing apparatus when capturing the second image at a first time on a basis of an orientation of the image capturing apparatus when capturing the second image at the first time, and an orientation of the image capturing apparatus when capturing the second image at a second time that precedes the first time.

6. The image processing apparatus according to claim 5, wherein an orientation of the image capturing apparatus when capturing the second image is determined based on the positional shift between the feature point included in the first image and the feature point included in the second image.

7. The image processing apparatus according to claim 3, wherein an orientation change of the image capturing apparatus when capturing the second image is determined based on an output from a sensor included in the image capturing apparatus.

8. The image processing apparatus according to claim 7, wherein the sensor is a gyro sensor.

9. The image processing apparatus according to claim 2, wherein the predetermined condition includes a condition related to the number of feature points which have been searched for from the second image and which correspond to feature points included in the first image.

10. The image processing apparatus according to claim 2, wherein the one or more processors execute the instructions to determine whether the number of feature points which have been searched for from the second image and which correspond to feature points included in the first image is equal to or larger than a threshold, and select the second image on a basis of a result of the determination.

11. The image processing apparatus according to claim 2, wherein the predetermined condition includes a condition related to a difference between the second image and the first image.

12. The image processing apparatus according to claim 2, wherein the one or more processors execute the instructions to determine whether a difference between information of the feature point included in the first image and information of the feature point which has been searched for from the second image and which corresponds to the feature point included in the first image is equal to or smaller than a predetermined reference, and select the second image on a basis of a result of the determination.

13. The image processing apparatus according to claim 2, wherein the one or more processors execute the instructions to
with respect to each of a plurality of feature points included in the first image, calculate a difference between a feature amount related to a feature point included in the first image and a feature amount related to a feature point which has been searched for from the second image and which corresponds to the feature point included in the first image, and
determine whether a sum total of the differences calculated for the plurality of feature points included in the first image is equal to or smaller than a predetermined threshold, and select the second image based on determining that the sum total of the differences is equal to or smaller than the predetermined threshold.

14. The image processing apparatus according to claim 2, wherein the one or more processors execute the instructions to determine the new search range on a basis of a statistical value of the positional shifts that have been evaluated respectively for the one or more second images.

15. The image processing apparatus according to claim 1, wherein the one or more processors execute the instructions to, based on a difference between the search range that acts as a reference and the determined new search range, determine whether to update the search range that is used to search for the feature point.

16. The image processing apparatus according to claim 1, wherein the one or more processors execute the instructions to search for the feature point which is included in the second image and which corresponds to the feature point included in the first image by evaluating each of difference between a feature amount of the feature point included in the first image and feature amounts of respective points inside the search range in the second image.

17. The image processing apparatus according to claim 1, wherein the one or more processors execute the instructions to, based on the determined positional shift between the feature point included in the first image and the feature point included in the second image, execute correction processing on the first image and/or the second image in order to align the first image and the second image.

18. An image processing apparatus comprising one or more memories storing instructions and one or more processors that execute the instructions to:
obtain information of a feature point included in a first image obtained by an image capturing apparatus;
search for a feature point which is included in a second image obtained by the image capturing apparatus and which corresponds to the feature point included in the first image from a search range set in the second image, and determine a positional shift between the feature point included in the first image and the feature point included in the second image;
determine whether an orientation change of the image capturing apparatus when capturing the second image is equal to or smaller than a predetermined reference, and when the orientation change has been determined to be equal to or smaller than the predetermined reference, determine a new search range to be set in the second image on a basis of information indicating the positional shift evaluated for the second image; and
update the search range on a basis of the determined new search range.

19. An image processing method comprising:
obtaining information of a feature point included in a first image obtained by an image capturing apparatus;
searching for a feature point which is included in a second image obtained by the image capturing apparatus and which corresponds to the feature point included in the first image from a search range set in the second image;
determining a positional shift between the feature point included in the first image and the feature point which is included in the second image and which corresponds to the feature point included in the first image;
determining a new search range to be set in the second image on a basis of information indicating a history of positional shifts that have been determined respectively for a plurality of second images obtained in sequence; and
updating the search range on a basis of the determined new search range.

20. A non-transitory computer-readable medium storing a program executable by a computer to perform a method comprising:
obtaining information of a feature point included in a first image obtained by an image capturing apparatus;
searching for a feature point which is included in a second image obtained by the image capturing apparatus and which corresponds to the feature point included in the first image from a search range set in the second image;
determining a positional shift between the feature point included in the first image and the feature point which is included in the second image and which corresponds to the feature point included in the first image;
determining a new search range to be set in the second image on a basis of information indicating a history of positional shifts that have been determined respectively for a plurality of second images obtained in sequence; and
updating the search range on a basis of the determined new search range.
